(19) United States
(12) Patent Application Publication
(10) Pub. No.: US 2005/0276164 A1
(43) Pub. Date: Dec. 15, 2005

(54) Watch adapted to rotate a displayed image so as to appear in a substantially constant upright orientation

(76) Inventor: Scott Amron, Nesconset, NY (US)

Correspondence Address: Scott Amron, P.O. Box 544, Plainview, NY, 11803-0544, US

(21) Appl. No.: 10/866,625

(22) Filed: Jun. 12, 2004

(51) Int. Cl. G04C 19/00

(52) U.S. Cl. 368/82

(57) ABSTRACT

A digital watch is provided having a viewing display for displaying images and including an orientation sensing module for sensing angular movement of the watch relative to at least one axis of rotation and a control module for rotating the image displayed on the viewing display to maintain the presentation of an image in a substantially constant upright orientation when directed (angled) toward a primary or secondary viewing person(s). As the user alters the orientation of the watch face, the tilt sensor(s) detects the change in device orientation. These changes in orientation are used to reorient the image being displayed on the viewing display of the watch.

### BACKGROUND OF THE INVENTION

1. Field of the Invention

The present invention relates to a watch adapted to rotate the image displayed on the viewing display of the watch to maintain the presentation of an image in a substantially constant upright orientation when directed (angled) toward a primary or secondary viewing person(s).

2. Background

Electronic watches made to include a viewing display are becoming increasingly common. Watches are now being designed to incorporate the functionality of music (MP3) players, digital cameras, photo players, televisions, wireless text messaging devices, cellular phones, timers, video game devices, PDA's, GPS tracking devices, etc. . . . Watches such as the Abacus Wrist Net “infowatch” from FOSSIL and the N3 spot-watch from SUUNTO exemplify the impending push for watches designed for increased convenience. This added functionality places greater pressure on the information displaying methods employed by a watch. The current methods used to visually present information to an immediate wearer of a wrist watch or the primary user of a pocket watch are insufficient in the redirection of visual media to a secondary viewing person(s).

Wrist watches are easily read by their immediate wearers. However, it is difficult for a secondary viewing person(s) to read from an upside down image presented on the viewing display of a wrist watch that is naturally tilted toward the secondary viewing person(s). Currently, the immediate wearer of a wrist watch must unnaturally twist their arm around to present the displayed image to a secondary viewing person(s) in the upright orientation. The requisite physical action of awkwardly rotating a watch 180 degrees to present an upright image to a secondary viewing person(s) located across from the primary viewing person(s) is to be remedied by the present invention.

Pocket watches (and digital stop watches) made to include a viewing display are currently designed with a single “right side up” orientation. With the current design the user must reposition the physical device in order to view the displayed image in the upright orientation. The present invention would allow for a more user friendly design as the image displayed on the viewing display would remain in the upright orientation despite the physical orientation of the pocket watch.

The present invention is directed toward overcoming one or more of the problems identified above. The term watch is defined as a portable timepiece and is used throughout this application as such. A pocket watch is defined herein as a portable timepiece carried in a pocket. A wrist watch is defined herein as a portable timepiece worn on the wrist of a person (a wearable timepiece).

### SUMMARY OF THE INVENTION

The present invention relates to a method, system, apparatus, and article of manufacture for rotating an image displayed on the viewing display of a watch to maintain an upright orientation when directed (angled) toward a primary or secondary viewing person(s). The present invention rotates the image displayed upon the viewing display of the watch based on the spatial orientation of the watch with respect to a normal gravitational field. A system in accordance with the principles of the present invention includes a watch comprising an information display capable of displaying a rotated image, an orientation sensing module for obtaining the physical orientation of the watch with respect to a normal gravitational field and a control module for rotating, calculating and driving the electronically displayed image. The image is rotated based upon the orientation of the viewing display of the watch to maintain the presentation of an upright image.

### BRIEF DESCRIPTION OF THE DRAWINGS

The various features, functions and advantages characterizing the invention will be better understood by reference to the detailed description which follows, taken in conjunction with the accompanying drawings, in which:

FIG. 1 is a perspective view of a digital wrist watch constructed in accordance with an illustrative embodiment of the present invention.

FIG. 2A-B are perspective views of a digital wrist watch constructed in accordance with an illustrative embodiment of the present invention.

FIG. 3 is a series of side views of a digital wrist watch constructed according to the preferred embodiment of the present invention included to demonstrate angular biasing.

FIG. 4A-D illustrate the orientation dependent rotation of a digital image presented on a wrist watch according to an embodiment of the present invention as worn on the wrist of a user.

FIG. 5A illustrates the orientation dependent rotation of a digital image presented on a digital pocket watch according to one embodiment of the present invention.

FIG. 5B illustrates the orientation dependant rotation of a digital image presented on a digital pocket watch according to one embodiment of the present invention.

FIG. 6 is a block diagram illustrating the components resident within, or attached to, the watch shown in FIG. 1.

FIG. 7 illustrates an operational flow for an image rotation and display processing system according to one embodiment of the present invention.

### DETAILED DESCRIPTION OF THE INVENTION

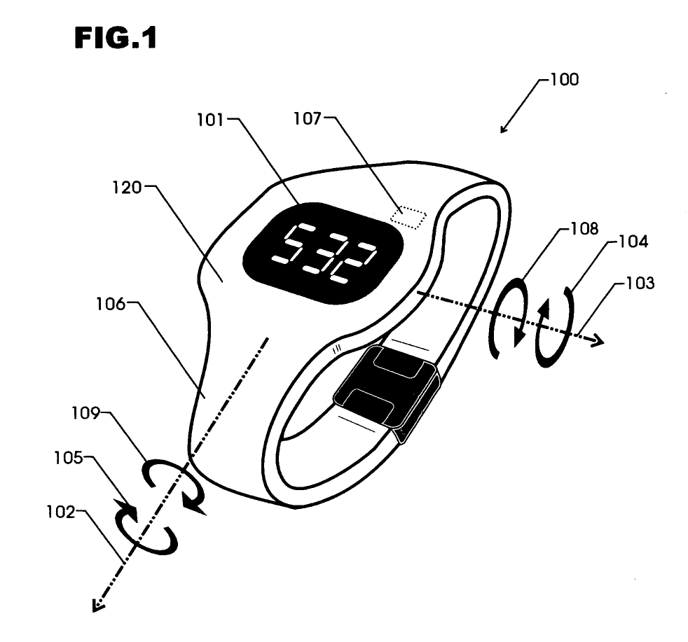

FIG. 1 illustrates a digital wrist watch constructed according to the preferred embodiment of the present invention, shown generally at 100. The digital wrist watch 100 includes a housing 120 having a top, a bottom, a front and a back, and a left side and a right side. A strap 106 is included for the attachment of the device to the wrist of a user. A viewing display 101 for displaying images is mounted at the top. The viewing display 101 is designed to correctly display images rotated in increments of 180 degrees, though a smaller incremental rotation is within the spirit and scope of the present invention. The viewing display 101 is a negative mode multiplexed 32-segment LCD. More advanced watches might include an OLED (organic light-emitting diode) display or a dot matrix LCD for visually communicating more information than just the “Time of Day”.

The orientation of the digital watch 100 is provided using an accelerometer 107, such as the ADXL311 dual-axis accelerometer device from ANALOG DEVICES, of Norwood, Mass. Such a device is small in size and may be mounted within the housing 120 of the digital watch 100 on a plane parallel with the display face. One skilled in the relevant art will appreciate that other sensor/accelerometer attachment orientations may be implemented without departing from the spirit and scope of the present invention. The accelerometer uses the force of gravity as an input vector to determine the orientation of the watch in space when used as a tilt sensor to sense static acceleration (e.g., gravity). As the digital watch 100 is tilted about the axis 103 in either the first 104 or the second 108 directions, the change in tilt may be detected by the orientation sensing module comprising the above mentioned accelerometer device. A digital watch designed to rotate a displayed image in increments smaller than 180 degrees would do so in response to a rotation about the axis 102 in either the first 105 or the second 109 directions as well as to a rotation about the axis 103 in either the first 104 or the second 108 directions. The orientation sensing module generates an electrical signal that may be sampled to allow the displayed image to be continuously updated. One skilled in the relevant art will appreciate that the orientation of the digital watch 200 can be provided using one or more accelerometers, or tilt sensors, or tilt switches, or inclinometers, or gyroscopes that are mounted onto or within the digital watch 200 in various orientations. Some examples of sensors that may be used in such a system include an accelerometer ADXL320 device from ANALOG DEVICES, of Norwood, Mass., a tilt sensing SQ-SEN-001PS device with mechanical ball in tube construction from SignalQuest, of Lebanon, N.H., a single axis miniature electrolytic tilt sensor of the NSM Series offered by Nanotron, Inc, of Tempe, Ariz., a miniature tilt switch D6B from OMRON Electronic, of USA, etc. . . .

A digital watch such as that described herein as the preferred embodiment, comprising an orientation sensing module employing an accelerometer device for sensing tilt about the axes 103, may also be made to function as a pedometer or workout level indicator by taking advantage of the inertial sensing capabilities of an orientation sensing module comprising an accelerometer. This is made possible since the accelerometer can sense tilt and also measure dynamic acceleration (e.g. vibration), thereby allowing the orientation sensing module to function dually as a tilt sensor and as an inertial sensing device.

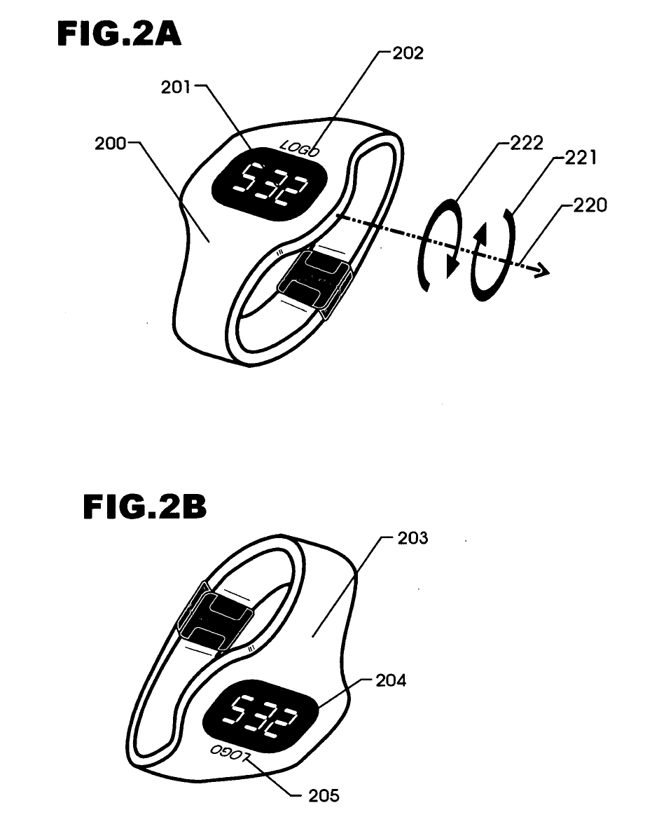

FIG. 2A is a perspective view of a digital wrist watch constructed in accordance with an illustrative embodiment of the present invention. The digital wrist watch 200 is shown as being angled toward a primary viewing person or the wearer of the wrist watch. Typically, a logo of the company producing the watch is printed on the watch itself. The Logo 202 is included here only to illustrate that the watch 200 is positioned in its natural upright orientation. The displayed image 201 is also presented in the upright orientation as is currently the case with all watches. FIG. 2B is a perspective view of the same digital wrist watch 203 as that pictured in FIG. 2A, 200 rotated about the axis 220 so as to be angled toward a secondary viewing person(s). The upside down Logo 205 is included here only to illustrate that the watch 203 is tilted toward a secondary viewing person(s), angled away from the primary viewing person. The displayed image 204 is also presented in the upright orientation as is NOT the case with watches currently on the market. The automatic rotation of the displayed image based on the physical orientation of the watch to present an upright image is noted.

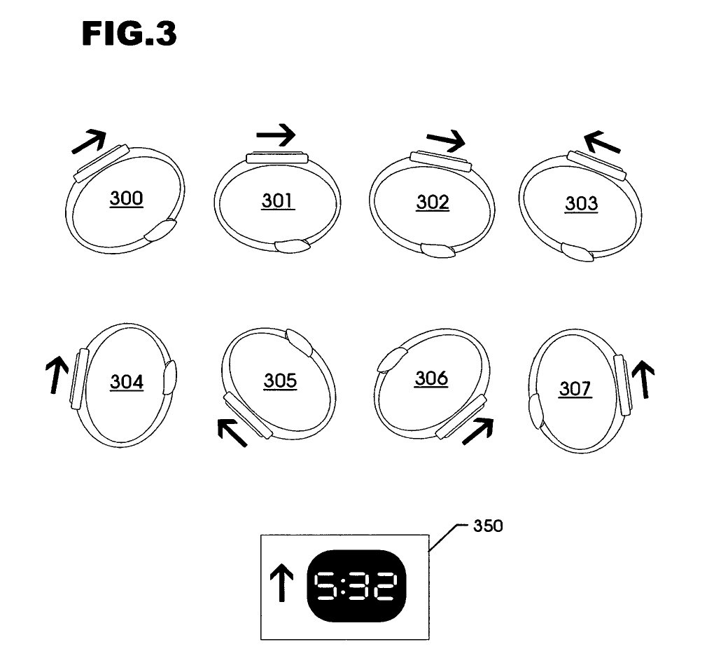

FIG. 3 is a series of side views illustrating the degree to which the wrist watch of FIG. 1 must be rotated about the axis 103 to trigger a 180 degree image rotation. Arrows are placed above the viewing display of the watch pictured in each frame of rotation to indicate the orientation of the displayed image. The arrows point in the direction of the top of the displayed image as is illustrated by 350. Side views 300, 301, 302, 304 and 305 are shown to display an upright image in the watch's natural upright orientation for easy viewing by the primary viewing person or the wearer of the wrist watch. Side views 303, 306 and 307 are shown to display an image that is presented in the upright orientation to a secondary viewing person(s). The degree of tilt about the axis 103 at which the image rotates 180 degrees is between side views 302 and 303. The degree of tilt at which the image rotates 180 degrees is biased to provide the wearer of the watch with an upright image in a greater number of watch orientations.

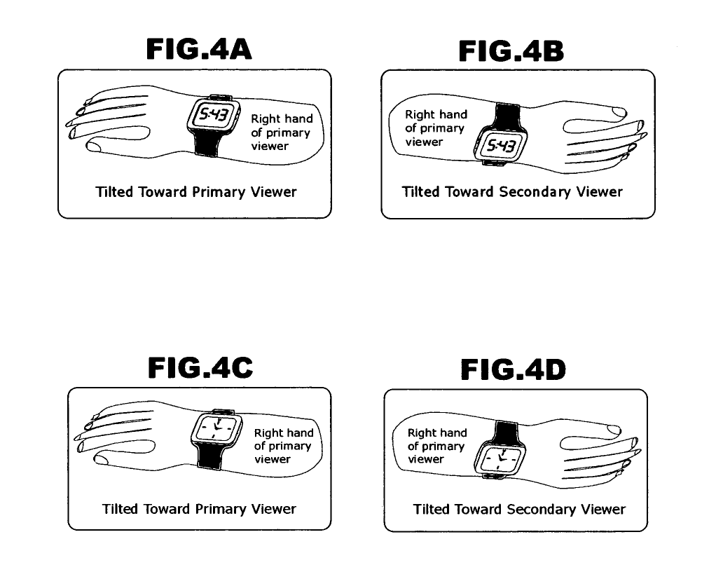

FIG. 4A-D illustrate a digital wrist watch constructed according to the preferred embodiment of the present invention as worn on the wrist of a user. FIG. 4A and FIG. 4B show the information being displayed on a seven segment LCD. FIG. 4C and FIG. 4D show the information being displayed on a segmented LCD designed to mimic that of a real analog timepiece. FIG. 4A shows the right hand of the primary viewing person tilting the display face toward him or herself to view the image in an upright orientation. FIG. 4B shows the right hand of the same primary viewing person tilting the display face toward a secondary viewing person(s) to present an upright image to a secondary viewing person(s). The rotation of the image displayed on the display of the wrist watch is noted.

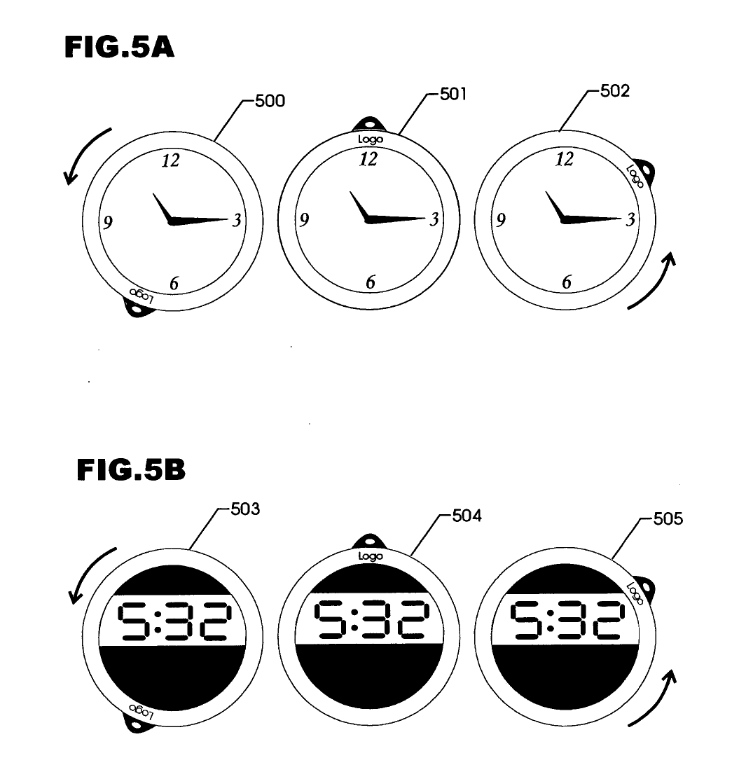

FIG. 5A and FIG. 5B illustrate a digital pocket watch constructed according to another embodiment of the present invention. The image displayed on the watch face is rotated based upon the orientation of the viewing display in two dimensions (pitch and roll) to present an image with an upright orientation despite angular reorientation of the housing and image display. The image is rotated in increments smaller than 5 degrees to continuously present an upright image. FIG. 5A shows the information being displayed on a circular segmented LCD designed to mimic that of a real analog timepiece.

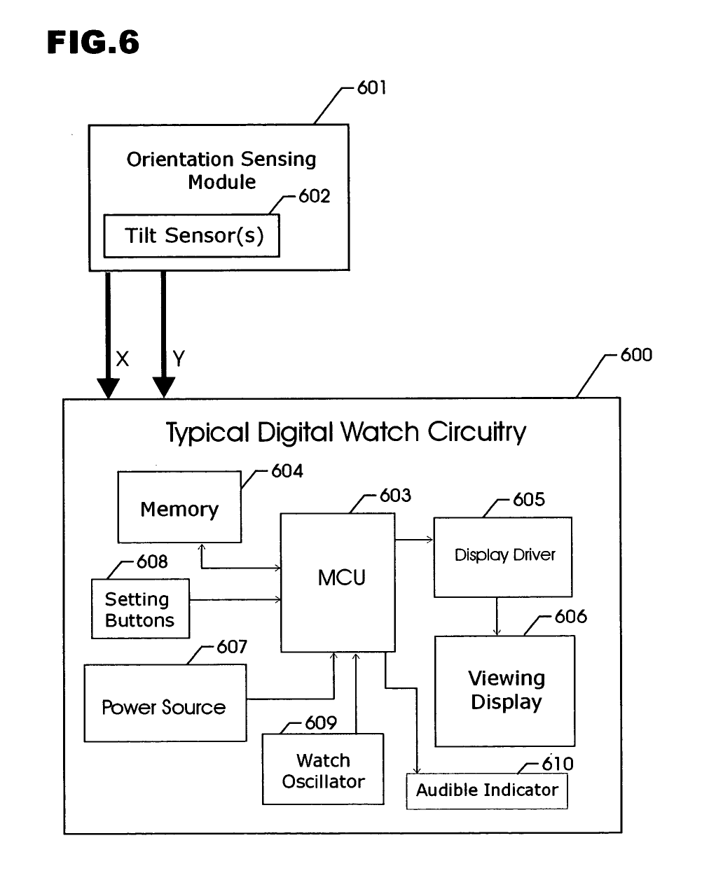

FIG. 6 is a block diagram illustrating the components resident within, or attached to, the housing 120 of the digital watch 100 shown in FIG. 1. With reference to FIG. 6, it can be seen that the image rotation, orientation data processing, timing and information displaying operations are controlled by the control module 600 typical of a digital watch. In the illustrative embodiment of FIG. 6, the control module 600 includes a power source 607 that includes one or more batteries (not shown) or a storage component such as a capacitor, a programmable microprocessor unit (MCU) 603 characterized by a relatively low current consumption for extended operation, a watch oscillator 609 comprising a watch crystal with a frequency of 32.768 kHz, a memory module 604 for storage of program memory and randomly accessible variables, a display driver 605 for driving the viewing display, a viewing display 606, an audible indicator 610 such as an externally driven piezo sounder for audibly communicating an event and a user control input 608 for setting user controlled parameters. The MCU 603 may be implemented by either an application specific integrated circuit (ASIC) or using a commercially available microprocessor unit programmed to process orientation information and to drive the user interface of the watch. It is the goal of the present invention to add orientation sensing, orientation data processing and image rotation operations to the functionality of a digital watch that processes data and drives an information display. The orientation sensing module 601 comprises at least one tilt sensor for sensing angular movement of the housing relative to at least one axis of rotation and to generate an electrical signal representative of a change in the physical orientation of the display device.

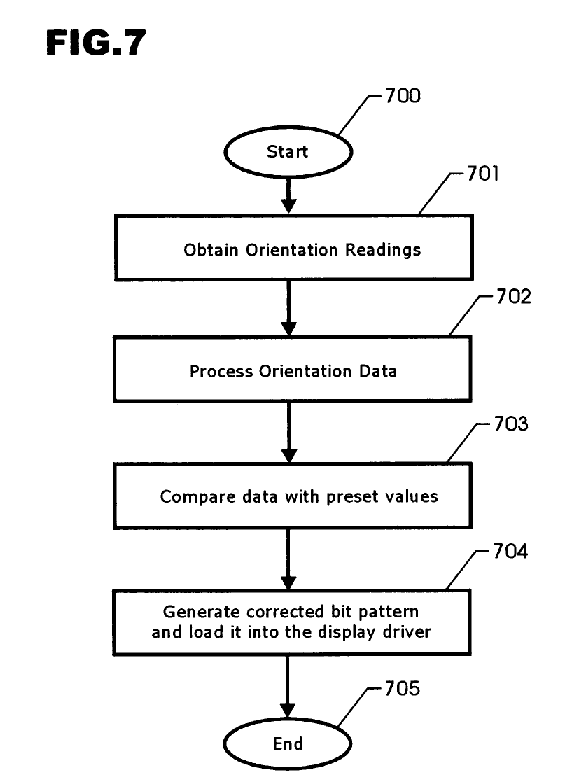

FIG. 7 illustrates an operational flow for an image rotation and display processing system according to yet another embodiment of the present invention. The processing begins 700 and a set of readings are obtained in module 701 in order to determine the orientation of the watch. The set of readings are taken for measuring the orientation of the watch in at least one dimension. These measurements are then processed within module 702 to determine the degree to which the watch is rotated about each of the monitored axes of rotation. The degree of tilt is then compared in module 703 with at least one preset number to determine the number of increments that the image must be rotated to compensate and in which direction. A corrected bit pattern is then generated and loaded into the display driver to drive the viewing display with an updated image in module 704.

While this invention has been illustrated and described in accordance with a preferred embodiment of the present invention, it is recognized that variations and changes may be made therein. Thus, for example, while the illustrative embodiments shown and described herein have employed control modules comprised of circuitry typical of current digital watches, modification to such circuitry to monitor device orientation is implied by the very nature of the invention. As such, it suffices to say that the scope of the invention disclosed herein should not be limited by the specific embodiments illustrated, but rather by the claims appended hereto.

1. A watch adapted to display an image and to reorient an image displayed thereon in response to a change in physical orientation of the image display, the watch comprising:
a housing;
an image display operatively associated with the housing;
display driver circuitry;
a tilt sensing module adapted to sense angular movement of the housing relative to at least one axis of rotation and to generate an electrical signal representative of a change in the physical orientation of the watch; and
a control module responsive to said electrical signal to reorient (rotate) the displayed image so as to appear in a substantially constant upright orientation relative to said axis of rotation despite angular reorientation of the housing and image display.

2. The watch according to claim 1, wherein the tilt sensing module comprises at least one accelerometer to measure the orientation of the image display to a normal gravitational field.

3. The watch according to claim 1, wherein the tilt sensing module comprises at least one tilt sensor to measure the orientation of the image display.

4. The watch according to claim 1, wherein the tilt sensing module comprises at least one tilt switch to measure the orientation of the image display to a normal gravitational field.

5. The watch according to claim 1, wherein the tilt sensing module comprises an inclinometer or a gyroscope to measure the tilt of the image display.

6. The watch according to claim 1, wherein the corrective rotation of the displayed image is executed in increments of 180 degrees.

7. The watch according to claim 1, wherein the corrective rotation of the displayed image is executed in increments smaller than 360 degrees.

8. The watch according to claim 1, constructed as a pocket watch.

9. The watch according to claim 1, constructed as a wrist watch.

10. The watch according to claim 1, constructed as a wearable timepiece/PDA or a timepiece/music player or a timepiece/wireless telephone or timepiece/wireless text messaging device or a timepiece/SPOT device or a timepiece/GPS device or a timepiece/television or a timepiece/digital camera or a timepiece/photo player or a timepiece/video player or any combination of the above.

11. The watch according to claim 1, wherein the image display is the face plate (background) of an analog watch.

12. The watch according to claim 2, wherein a temporary reorientation of the displayed image is triggered by a thrusting hand motion sensed by the tilt sensing module and executed by the control module.

13. The watch according to claim 2, wherein the tilt sensing module doubles as an inertial sensing module for additional pedometer functionality and/or workout activity level reporting functionality.

14. A method for rotating an image displayed upon a watch comprising the steps of:
generating an electrical signal representative of a change in physical orientation of the watch display; and
reorienting the image displayed on the watch display to appear in a substantially constant upright orientation despite a change in physical orientation of the watch in response to the electrical signal obtained during the generating step.

15. A watch designed to automatically rotate the image displayed on its viewing display upon being tilted toward a secondary viewing person(s) for presenting an image in the upright orientation to the secondary viewing person(s) by means of tilt sensing.
